(19) United States
(12) Patent Application Publication
(10) Pub. No.: US 2019/0354115 A1
(43) Pub. Date: Nov. 21, 2019

(54) CONTROL METHOD, DEVICE, AND GIMBAL

(71) Applicant: SZ DJI TECHNOLOGY CO., LTD., Shenzhen (CN)

(72) Inventor: Wei ZHANG, Shenzhen (CN)

(21) Appl. No.: 16/529,505

(22) Filed: Aug. 1, 2019

Related U.S. Application Data
(63) Continuation of application No. PCT/CN2017/085855, filed on May 25, 2017.

(51) Int. Cl. G05D 1/08; G05D 1/10; G05D 1/04; H04N 5/232; G05D 3/12

(52) U.S. Cl. CPC G05D 1/0808; G05D 1/101; B64C 2201/14; H04N 5/232; G05D 3/12; G05D 1/042

(57) ABSTRACT

A method for controlling a gimbal includes obtaining a drift pixel of at least one target characteristic point in multiple frames of images. The method also includes determining a drift angle of an imaging device based on the drift pixel of the at least one target characteristic point and an imaging parameter of the imaging device. The method further includes adjusting an attitude of the gimbal based on the drift angle.

### CROSS-REFERENCE TO RELATED APPLICATION

This application is a continuation application of International Application No. PCT/CN2017/085855, filed on May 25, 2017, the entire content of which is incorporated herein by reference.

### TECHNICAL FIELD

The present disclosure relates to the technology field of electronics and, more particularly, to a control method, a device, and a gimbal.

### BACKGROUND

In applications of aircraft tracking target objects, an aircraft may track and capture images of the target object through an imaging device. In the process of tracking and capturing images of the target object, due to the shake or vibration of the aircraft, the tracking images may become unstable. As a result, the effect of tracking may not be satisfactory.

Currently, mainstream aircraft image stabilization technologies use sensors to detect the shaking or vibration of the body of the aircraft, thereby controlling a motor to perform a counter movement to mitigate the effect of the shaking or vibration. However, a slight drift of the gimbal may be magnified as the zoom magnification is increased. Therefore, these slight drift or vibration may cause a significant effect on the stability of the images captured by the imaging device.

### SUMMARY

In accordance with an aspect of the present disclosure, there is provided a method for controlling a gimbal. The method includes obtaining a drift pixel of at least one target characteristic point in multiple frames of images. The method also includes determining a drift angle of an imaging device based on the drift pixel of the at least one target characteristic point and an imaging parameter of the imaging device. The method further includes adjusting an attitude of the gimbal based on the drift angle.

In accordance with another aspect of the present disclosure, there is provided a gimbal. The gimbal includes a processor and a storage device connected with the processor through a bus. The storage device is configured to store a computer-executable program code. The processor is configured to retrieve and execute the computer-executable program code to obtain a drift pixel of at least one target characteristic point in multiple frames of images. The processor is also configured to retrieve and execute the computer-executable program code to determine a drift angle of an imaging device based on the drift pixel of the at least one target characteristic point and an imaging parameter of the imaging device. The processor is further configured to retrieve and execute the computer-executable program code to adjust an attitude of a gimbal based on the drift angle.

In accordance with another aspect of the present disclosure, there is provided an unmanned aerial vehicle (“UAV”). The UAV includes an imaging device and a gimbal. The gimbal includes a processor and a storage device connected with the processor. The storage device is configured to store a computer-executable program code. The processor is configured to retrieve and execute the computer-executable program code to obtain a drift pixel of at least one target characteristic point in multiple frames of images. The processor is also configured to retrieve and execute the computer-executable program code to determine a drift angle of an imaging device based on the drift pixel of the at least one target characteristic point and an imaging parameter of the imaging device. The processor is further configured to retrieve and execute the computer-executable program code to adjust an attitude of the gimbal based on the drift angle. The UAV further includes an airframe. The imaging device is mounted to the gimbal, and the gimbal is mounted to the airframe.

According to the technical solution of the present disclosure, a drift angle of an imaging device may be determined based on a drift pixel of at least one target characteristic point in multiple frames of images and an imaging parameter of the imaging device. Further, an attitude of a gimbal may be adjusted based on the drift angle. Stability of tracking images (e.g., images of tracked target objects) may be adaptively increased.

### BRIEF DESCRIPTION OF THE DRAWINGS

To better describe the technical solutions of the various embodiments of the present disclosure, the accompanying drawings showing the various embodiments will be briefly described. As a person of ordinary skill in the art would appreciate, the drawings show only some embodiments of the present disclosure. Without departing from the scope of the present disclosure, those having ordinary skills in the art could derive other embodiments and drawings based on the disclosed drawings without inventive efforts.

FIG. 1 is a flow chart illustrating a control method, according to an example embodiment.

FIG. 2 is a flow chart illustrating another control method, according to an example embodiment.

FIG. 3 is a schematic diagram of a control device, according to an example embodiment.

FIG. 4 is a schematic diagram of a gimbal, according to an example embodiment.

### DETAILED DESCRIPTION OF THE EMBODIMENTS

Technical solutions of the present disclosure will be described in detail with reference to the drawings, in which the same numbers refer to the same or similar elements unless otherwise specified. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

As used herein, when a first component (or unit, element, member, part, piece) is referred to as “coupled,” “mounted,” “fixed,” “secured” to or with a second component, it is intended that the first component may be directly coupled, mounted, fixed, or secured to or with the second component, or may be indirectly coupled, mounted, or fixed to or with the second component via another intermediate component. The terms “coupled,” “mounted,” “fixed,” and “secured” do not necessarily imply that a first component is permanently coupled with a second component. The first component may be detachably coupled with the second component when these terms are used. When a first component is referred to as “connected” to or with a second component, it is intended that the first component may be directly connected to or with the second component or may be indirectly connected to or with the second component via an intermediate component. The connection may include mechanical and/or electrical connections. The connection may be permanent or detachable. The electrical connection may be wired or wireless. When a first component is referred to as “disposed,” “located,” or “provided” on a second component, the first component may be directly disposed, located, or provided on the second component or may be indirectly disposed, located, or provided on the second component via an intermediate component. When a first component is referred to as “disposed,” “located,” or “provided” in a second component, the first component may be partially or entirely disposed, located, or provided in, inside, or within the second component. The terms “perpendicular,” “horizontal,” “vertical,” “left,” “right,” “up,” “upward,” “upwardly,” “down,” “downward,” “downwardly,” and similar expressions used herein are merely intended for describing relative positional relationship.

In addition, the singular forms “a,” “an,” and “the” are intended to include the plural forms as well, unless the context indicates otherwise. The terms “comprise,” “comprising,” “include,” and the like specify the presence of stated features, steps, operations, elements, and/or components but do not preclude the presence or addition of one or more other features, steps, operations, elements, components, and/or groups. The term “and/or” used herein includes any suitable combination of one or more related items listed. For example, A and/or B can mean A only, A and B, and B only. The symbol “/” means “or” between the related items separated by the symbol. The phrase “at least one of” A, B, or C encompasses all combinations of A, B, and C, such as A only, B only, C only, A and B, B and C, A and C, and A, B, and C. In this regard, A and/or B can mean at least one of A or B. The term “module” as used herein includes hardware components or devices, such as circuit, housing, sensor, connector, etc. The term “communicatively couple(d)” or “communicatively connect(ed)” indicates that related items are coupled or connected through a communication channel, such as a wired or wireless communication channel. The term “unit” or “module” may encompass a hardware component, a software component, or a combination thereof. For example, a “unit” or “module” may include a processor, a portion of a processor, an algorithm, a portion of an algorithm, a circuit, a portion of a circuit, etc.

Further, when an embodiment illustrated in a drawing shows a single element, it is understood that the embodiment may include a plurality of such elements. Likewise, when an embodiment illustrated in a drawing shows a plurality of such elements, it is understood that the embodiment may include only one such element. The number of elements illustrated in the drawing is for illustration purposes only, and should not be construed as limiting the scope of the embodiment. Moreover, unless otherwise noted, the embodiments shown in the drawings are not mutually exclusive, and they may be combined in any suitable manner. For example, elements shown in one embodiment but not another embodiment may nevertheless be included in the other embodiment.

In some embodiments, tracking and surveillance of a tracking object may be realized through an aircraft carrying an imaging device. The aircraft may be an unmanned aerial vehicle (“UAV”), a flying robot, etc. The aircraft may carry the imaging device through a gimbal mounted to an airframe of the aircraft. To better realize tracking and imaging from multiple perspectives, the gimbal may be a three-axis gimbal. The gimbal may rotate around three rotation axes, a yaw axis, a pitch axis, and a roll axis. By controlling a rotation angle of the gimbal around one or more rotation axis, tracking and imaging of the target object by the aircraft such as the UAV during a process of moving toward a destination or direction may be better realized.

In some embodiments, the tracking object may be a human, an area on the ground, a building, or an animal, etc. The target characteristic point may be a part (e.g., nose, eye, etc.) of a human or an area of an object (e.g., a top level of a building). The present disclosure does not limit the tracking object.

In some embodiments, the imaging device may be a general camera, or a high-magnification zooming camera, which is not limited by the present disclosure.

Currently, relatively mainstream aircraft image stabilization technology uses a sensor to detect shaking or vibration of the body of the aircraft, thereby controlling a motor to perform a counter movement to mitigate the effect of the shaking or vibration. However, a slight drift of the gimbal may be magnified as the zoom magnification of the imaging device is increased. Therefore, the slight drift, shaking, and vibration may cause a relatively significant effect on the stability of the images captured by the imaging device. The present disclosure provides a control method that includes adjusting an attitude of the gimbal based on a drift angle of the imaging device to increase the stability of tracking images.

In some embodiments, the aircraft may obtain a drift pixel (or one or more drift pixels) of at least one target characteristic point in multiple frames of images. The multiple frames of images may include images continuously captured by the imaging device. A drift angle of the imaging device may be determined based on the drift pixel of the at least one target characteristic point and an imaging parameter of the imaging device. The attitude of the gimbal may be adjusted based on the drift angle to increase the stability of the tracking images.

In some embodiments, the drift angle may include one or both of a drift distance in a horizontal direction or a vertical direction.

In some embodiments, the imaging parameter may include one or more of a field of view angle in the horizontal direction, a field of view angle in a vertical direction, a focal length, or a photosensitivity parameter.

In some embodiments, the drift pixel may refer to a moving distance of at least one target characteristic point between every two frames of images, such as a moving distance in the horizontal direction, and/or a moving distance in the vertical direction.

It is understood that steps of the method of the present disclosure may be executed by the aircraft, or the gimbal mounted to the aircraft, which is not limited by the present disclosure.

The present disclosure provides a control method, a device, and a gimbal, which are configured to adjust the attitude of the gimbal based on the drift angle of the imaging device. The disclosed control method, device, and gimbal may adaptively increase the stability of the tracking images. The following descriptions will explain the control method, the device, and the gimbal in detail.

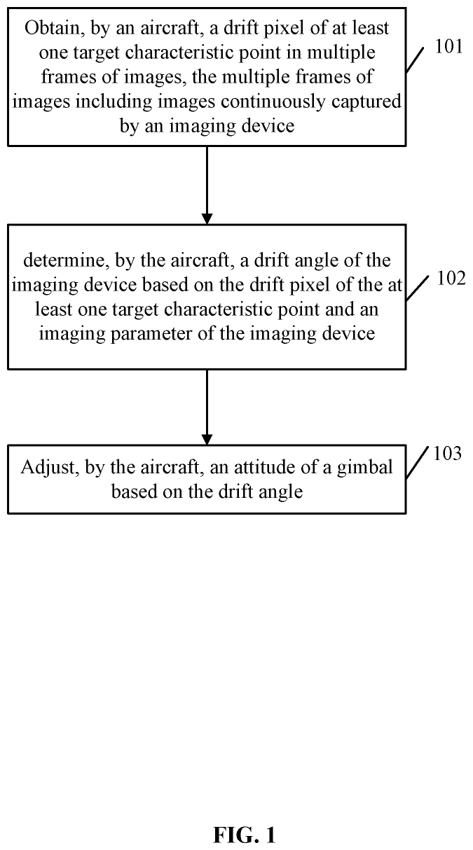

FIG. 1 is a flow chart illustrating a control method, according to an embodiment of the present disclosure. The control method may include:

Step 101: obtaining, by the aircraft, a drift pixel of at least one target characteristic point in multiple frames of images, the multiple frames of images including images continuously captured by an imaging device.

In some embodiments, the drift pixel may refer to a drift distance of the at least one target characteristic point in every two frames of images, such as a drift distance in the horizontal direction, and/or a drift distance in the vertical direction.

In some embodiments, the target characteristic point may include a part (e.g., nose, eye, etc.) of a human, or an area of an object (e.g., a top level of a building), which is not limited by the present disclosure.

In some embodiments, a method in which the aircraft calculates the drift pixel of the at least one target characteristic point in the multiple frames of images may include: for each target characteristic point included in the at least one target characteristic point, obtaining, by the aircraft, drift pixels of the target characteristic point in a selected number of frames of images from the multiple frames of images, to obtain multiple groups of drift pixels. The drift pixel of the target characteristic point may be obtained from the multiple groups of drift pixels.

For example, obtaining, by the aircraft, the drift pixels of the target characteristic point in a selected number of frames of images from the multiple frames of images may include: obtaining the drift pixels of the target characteristic point in the first predetermined number of frames of images (e.g., the first 5 frames of images); or obtaining the drift pixels of the target characteristic point in the last predetermined number of frames of images (e.g., the last 10 frames of images); or obtaining the drift pixels of the target characteristic point in a random number of frames of images (e.g., the last eight frames of images). Through one or more of the above methods, multiple groups of drift pixels of the target characteristic point may be obtained. The drift pixel of the target characteristic point may be obtained from the multiple groups of drift pixels.

In some embodiments, the method in which the aircraft obtains the drift pixel of the at least one target characteristic point in the multiple frames of images may include: for each target characteristic point of the at least one target characteristic point, determining a drift pixel in a horizontal direction and a drift pixel in a vertical direction for the target characteristic point based on the multiple groups of drift pixels of the target characteristic point in the multiple frames of images.

In some embodiments, for each target characteristic point of the at least one target characteristic point, the aircraft may determine the drift pixel of the target characteristic point as the drift pixels of the target characteristic point in two frames of images (e.g., the first frame of image and the last frame of image) in the multiple frames of images.

In some embodiments, each group of drift pixel in the multiple groups of drift pixels may include a drift pixel in the horizontal direction and a drift pixel in the vertical direction.

In some embodiments, the method in which the aircraft obtains drift pixel of the target characteristic point based on multiple groups of drift pixels may include: selecting a group of drift pixel from the multiple groups of drift pixels as the drift pixel of the target characteristic point.

For example, for each target characteristic point of at least one target characteristic point, the aircraft may calculate the drift pixels of the target characteristic point in the multiple frames of images to obtain multiple groups of drift pixels. The aircraft may select the largest group of drift pixel from the multiple groups of drift pixels as the drift pixel of the target characteristic point, or may randomly select a group of drift pixel from the multiple groups of drift pixels as the drift pixel of the target characteristic point, or may select a group of drift pixel that is closest to an average drift pixel of the multiple groups of drift pixels as the drift pixel of the target characteristic point.

In some embodiments, the method in which the aircraft determines the drift pixel of the target characteristic point based on the multiple groups of drift pixels may include: calculating an average drift pixel of the multiple groups of drift pixels, and determining the average drift pixel as the drift pixel of the target characteristic point.

In some embodiments, for each target characteristic point of the at least one target characteristic point, the aircraft may calculate the drift pixels of the target characteristic point in the multiple frames of images to obtain multiple groups of drift pixels. The aircraft may respectively calculate an average drift pixel in the horizontal direction and an average drift pixel in the vertical direction based on the multiple groups of drift pixels. The aircraft may determine the calculated average drift pixel in the horizontal direction and the calculated average drift pixel in the vertical direction as the drift pixel of the target characteristic point in the horizontal direction and the drift pixel of the target characteristic point in the vertical direction, respectively.

In some embodiments, prior to executing the step 101, the aircraft may further execute the following steps: obtaining multiple characteristic points from a central area of a first frame of image in the multiple frames of images; and filtering the multiple characteristic points based on location information of the multiple characteristic points in the multiple frames of images to obtain at least one target characteristic point.

In some embodiments, the aircraft may obtain multiple characteristic points from the central area of the first frame of image in the multiple frames of images, and filter the multiple characteristic points based on the location information of the multiple characteristic points in the multiple frames of images to obtain at least one target characteristic point.

In some embodiments, the method in which the aircraft filters the multiple characteristic points to obtain at least one target characteristic point may include: for each characteristic point in the multiple characteristic points, determining a movement path of the characteristic point based on the location information of the characteristic point in the multiple frames of images; comparing the movement path of the characteristic point with a predetermined movement model; if the movement path of the characteristic point matches the predetermined movement model, the aircraft may determine the characteristic point as the target characteristic point.

In some embodiments, the aircraft may determine the movement path of the characteristic point based on the location information of the characteristic point in the multiple frames of images. The movement path may include a moving direction and a moving distance. If the moving direction of the movement path of the characteristic point is consistent with a moving direction of the predetermined movement model, the aircraft may determine that the moving direction of the movement path of the characteristic point matches the moving direction of the predetermined movement model. In some embodiments, if the moving distance of the movement path of the characteristic point matches a moving distance of the predetermined movement model, for example, if an absolute value of a difference between the moving distance of the movement path of the characteristic point and the moving distance of the predetermined movement model is smaller than a predetermined value, the aircraft may determine that the moving distance of the movement path of the characteristic point matches the moving distance of the predetermined movement model. In other words, the aircraft may determine that the movement path of the characteristic point matches the predetermined movement model, and the characteristic point may be determined as the target characteristic point.

In some embodiments, the predetermined movement model may be established based on movement paths of a predetermined number of characteristic points included in the at least one target characteristic point. The predetermined number may be set based on a total number of characteristic points included in the at least one target characteristic point.

In some embodiments, the movement model may include a moving direction, a moving distance, etc. The movement path may include a moving direction, a moving distance, etc.

In some embodiments, the method in which the aircraft filters the multiple characteristic points to obtain at least one target characteristic point may include: for each characteristic point of the multiple characteristic points, determining a movement path of the characteristic point based on location information of the characteristic point in the multiple frames of images; comparing the movement path of the characteristic point with a movement model of an imaging device; if the movement path of the characteristic point matches the movement model of the imaging device, the aircraft may determine the characteristic point as the target characteristic point.

In some embodiments, the movement model of the imaging device may be configured based on the movement path of the imaging device.

In some embodiments, the aircraft may determine a moving direction and a moving distance of the movement path of the characteristic point based on location information of the characteristic point in the multiple frames of images. When the moving distance and moving direction of the moving characteristic point match a moving distance and a moving direction of the movement model of the imaging device, respectively, the aircraft may determine that the movement path of the characteristic point matches the movement model of the imaging device, and that the characteristic point may be determined as the target characteristic point.

In some embodiments, the method in which the aircraft filters the multiple characteristic points to obtain at least one target characteristic point may include: for each characteristic point in the multiple characteristic points, determining a movement path of the characteristic point based on location information of the characteristic point in the multiple frames of images; comparing the movement path of the characteristic point with a movement model of an imaging device and a predetermined movement model; if the movement path of the characteristic point matches the movement model of the imaging device and the predetermined movement model, determining the characteristic point as the target characteristic point.

Step 102: determining, by the aircraft, a drift angle of the imaging device based on a drift pixel of the at least one target characteristic point and an imaging parameter of the imaging device.

In some embodiments, after obtaining the drift pixel of the at least one target characteristic point, the aircraft may determine a drift angle of the imaging device based on the drift pixel of the at least one target characteristic point and the imaging parameter of the imaging device, such that an attitude of a gimbal may be adjusted based on the drift angle of the imaging device.

In some embodiments, the drift angle may include one or both of a drift distance in the horizontal direction or a drift distance in the vertical direction.

In some embodiments, the imaging parameter may include one or more of a field of view angle in the horizontal direction, a field of view angle in the vertical direction, a focal length, or a photosensitivity parameter.

In some embodiments, the method in which the aircraft determines the drift angle of the characteristic point may include: for each target characteristic point included in the at least one target characteristic point, determining a drift angle corresponding to the target characteristic point based on the drift pixel of the target characteristic point and the imaging parameter of the imaging device; and determining a drift angle of the imaging device based on a drift angle corresponding to each target characteristic point included in the at least one target characteristic point.

In some embodiments, the method in which the aircraft determines the drift angle of the imaging device based on a drift angle corresponding to each target characteristic point included in the at least one target characteristic point may include: calculating an average drift angle of the at least one target characteristic point, and determining the average drift angle as the drift angle of the imaging device.

In some embodiments, the method in which the aircraft determines the drift angle of the imaging device based on a drift angle corresponding to each target characteristic point included in the at least one target characteristic point may include: determining a drift angle corresponding to any target characteristic point included in the at least one target characteristic point as the drift angle of the imaging device. For example, a drift angle corresponding to a target characteristic point having the largest drift angle in the at least one target characteristic point may be determined as the drift angle of the imaging device.

In some embodiments, the method in which the aircraft determines the drift angle of the imaging device based on a drift angle corresponding to each target characteristic point included in the at least one target characteristic point may include: filtering the drift angle of the at least one target characteristic point to obtain the drift angle of the imaging device.

For example, for each target characteristic point included in the at least one target characteristic point, the aircraft may determine a drift angle corresponding to the target characteristic point based on a drift pixel of the target characteristic point and a field of view angle of the imaging device. The aircraft may apply a Kalman filter on the drift angle of the at least one target characteristic point to filter out a drift angle of a characteristic point that has been interfered by a noise, thereby obtaining the drift angle of the imaging device. The disclosed method may increase the accuracy of the drift angle.

In some embodiments, the method in which the aircraft determines the drift angle corresponding to the target characteristic point based on the drift pixel of the target characteristic point and the imaging parameter of the imaging device may include: determining a field of view angle of the imaging device based on the imaging parameter of the imaging device; and determining the drift angle corresponding to the target characteristic point based on the field of view angle of the imaging device and the drift pixel of the target characteristic point.

In some embodiments, the aircraft may determine the field of view angle of the imaging device based on the imaging parameter of the imaging device. The aircraft may determine the drift angle corresponding to the target characteristic point based on the field of view angle of the imaging device and the drift pixel of the target characteristic point, such that the drift angle of the imaging device may be determined based on the drift angle of the target characteristic point.

In some embodiments, the drift angle of the target characteristic point in the horizontal direction may be proportional to the drift pixel of the target characteristic point in the horizontal direction and the field of view angle of the imaging device in the horizontal direction. The drift angle of the target characteristic point in the horizontal direction may be inversely proportional to a width of the multiple frames of images. The drift angle of the target characteristic point in the vertical direction may be proportional to the drift pixel of the target characteristic point in the vertical direction and the field of view angle of the imaging device in the vertical direction. The drift angle of the target characteristic point in the vertical direction may be inversely proportional to a height of the multiple frames of images. Therefore, the method in which the aircraft determines the drift angle corresponding to the target characteristic point based on the drift pixel of the target characteristic point and the field of view angle of the imaging device may include: calculating a ratio between the field of view angle of the imaging device in the horizontal direction and the width of the multiple frames of images, and a product of multiplying the ratio by the drift pixel of the target characteristic point in the horizontal direction to obtain the drift angle of the target characteristic point in the horizontal direction; and calculating a ratio between the field of view angle of the imaging device in the vertical direction and the height of the multiple frames of images, and a product by multiplying the ratio by the drift pixel of the target characteristic point in the vertical direction to obtain the drift angle of the target characteristic point in the vertical direction. The equations for obtaining the drift angle of the target characteristic point may be:

Theta_x=FOV_X*Δx/W

Theta_y=FOV_Y*Δy/H

In the above equations, Δx and Δy represent the drift pixel of the target characteristic point in the horizontal direction and the vertical direction, respectively. FOV_X and FOV_Y represent the field of view angle of the imaging device in the horizontal direction and the vertical direction, respectively. W and H represent the width and the height of the multiple frames of images, respectively. Theta_x and Theta_y represent the drift angle of the target characteristic point in the horizontal direction and the vertical direction, respectively.

Step 103: adjusting an attitude of a gimbal based on the drift angle.

In some embodiments, the aircraft may directly use the drift angle to adjust the attitude of the gimbal to increase the stability of the tracking images.

In some embodiments, the method in which the aircraft adjusts the attitude of the gimbal based on the drift angle may include: obtaining a zoom magnification of the imaging device; determining a control parameter of the gimbal based on the drift angle and the zoom magnification; and adjusting the attitude of the gimbal based on the control parameter.

In some embodiments, the control parameter may include one or more control parameters in a proportion integration differentiation (“PID”) control.

In some embodiments, the drift or vibration of the gimbal relates to the zoom magnification of the imaging device. That is, a slight drift or vibration may be magnified as the zoom magnification of the imaging device is increased. For example, when the imaging device is a high magnification camera, the higher the zoom magnification used in imaging, the higher the magnification by which the slight drift or vibration of the gimbal may be magnified. For example, if the imaging device is a Z30 high magnification camera with a 30 times optical zoom and a 6 times digital zoom, as the zoom magnification used in imaging is increased, the slight drift or vibration of the gimbal may be magnified by 20 times or more. Therefore, the aircraft may determine the control parameter of the gimbal based on the drift angle and the zoom magnification. The aircraft may adjust the attitude of the gimbal based on the control parameter. According to the present disclosure, the attitude of the gimbal may be adaptively adjusted based on the zoom magnification of the imaging device. As a result, the stability of the tracking image may be increased.

In some embodiments, the attitude of the gimbal may be controlled by a PID control algorithm. The response speed and accuracy of controlling the attitude of the gimbal may relate to one or more PID control parameters. In some embodiments, the one or more PID control parameters may be dynamically optimized based on the zoom magnification of the imaging device and the drift angle, thereby increasing the response speed and accuracy.

For example, when the P parameter is fixed, the response speed of the control of the attitude of the gimbal becomes faster when an adjustment step is greater. The adjustment efficiency may be relatively high, but the adjustment accuracy may not be high. When the adjustment step is smaller, the adjustment accuracy may be relatively high, and the response speed of controlling the attitude of the gimbal may become slower. In some embodiments, when the adjustment step is relatively small, it may be possible tha the even when the current adjustment is not completed yet, the vibration or drift appeared again in the attitude of the gimbal. If adjustment of the attitude of the gimbal continues with the currently used control parameter, the adjustment accuracy may be relatively low. Therefore, the PID control parameter may be dynamically optimized based on the zoom magnification of the imaging device and the drift angle, to thereby increase the response speed and accuracy.

For example, the drift angle is that the drift distance in the horizontal direction, which is 3 degrees. The zoom magnification is 10 times. The aircraft may look up a table to obtain the control parameter of the gimbal based on the drift angle and the zoom magnification. If the control parameter includes a control parameter P=4.5, an adjustment step of 0.3 degree, the aircraft may quickly adjust the attitude of the gimbal on the yaw axis.

In some embodiments, the table may record the control parameter matching the drift angle and the zoom magnification. The table may be set based on historical control parameters.

For example, in applications such as power line inspection, park security patrol, forest fire-prevention patrol, the aircraft may fly at a high altitude. When the aircraft needs to observe a regional area on the ground, the aircraft may treat the regional area as a target characteristic point, and may increase the zoom magnification of the imaging device, such that a relatively clear observation of the target characteristic point may be achieved. The aircraft may calculate a drift pixel of the target characteristic point in the captured image. Based on the drift pixel of the target characteristic point, the aircraft may determine a drift angle of the imaging device. The aircraft may adjust the attitude of the gimbal based on the drift angle and the zoom magnification, to maintain the stability of the tracking images.

In some embodiments, when the aircraft performs a surveillance on a distant tracking object, by adjusting the attitude of the gimbal, not only the drift of the gimbal may be compensated for, the aircraft may also intelligently maintain an area of interest (i.e., at least one target characteristic point) in a central region of the tracking images, thereby conveniently increasing the stability of the tracking images, which further improves the tracking effect.

In some embodiments, the aircraft may obtain a drift pixel of at least one target characteristic point in multiple frames of images. The multiple frames of images may be images continuously captured by the imaging device. The aircraft may determine a drift angle of the imaging device based on the drift pixel o the target characteristic point and an imaging parameter of the imaging device. The aircraft may adjust the attitude of the gimbal based on the drift angle, thereby adaptively increasing the stability of the tracking images.

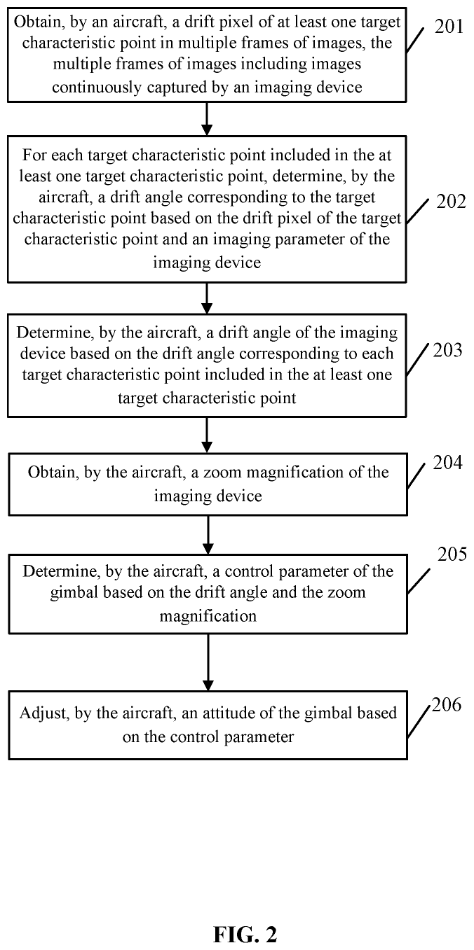

FIG. 2 is a flow chart illustrating another control method according to an embodiment of the present disclosure. The control method may include:

Step 201: obtaining, by an aircraft, a drift pixel of at least one target characteristic point in multiple frames of images, the multiple frames of images including images continuously captured by an imaging device.

Step 202: for each target characteristic point included in the at least one target characteristic point, determining, by the aircraft, a drift angle corresponding to the target characteristic point based on the drift pixel of the target characteristic point and an imaging parameter of the imaging device.

Step 203: determining, by the aircraft, a drift angle of the imaging device based on the drift angle corresponding to each target characteristic point included in the at least one target characteristic point.

In some embodiments, the method in which the aircraft determines the drift angle of the imaging device based on the drift angle corresponding to each target characteristic point included in the at least one target characteristic point may include: calculating an average drift angle of the at least one target characteristic point, and determining the average drift angle as the drift angle of the imaging device.

In some embodiments, the method in which the aircraft determines the drift angle of the imaging device based on the drift angle corresponding to each target characteristic point included in the at least one target characteristic point may include: determining a drift angle corresponding to any target characteristic point included in the at least one target characteristic point as the drift angle of the imaging device. For example, the drift angle corresponding to a target characteristic point included in the at least one target characteristic point, which is the largest drift angle, may be determined as the drift angle of the imaging device.

In some embodiments, the method in which the aircraft determines the drift angle of the imaging device based on the drift angle corresponding to each target characteristic point included in the at least one target characteristic point may include: filtering the drift angle of the at least one target characteristic point to obtain the drift point of the imaging device.

For example, for each target characteristic point included in the at least one target characteristic point, the aircraft may determine the drift angle corresponding to the target characteristic point based on the drift pixel of the target characteristic point and a field of view angle of the imaging device. A Kalman filter may be applied to the one or more drift angles corresponding to the at least one target characteristic point to filter out one or more drift angles that have been interfered by noise, thereby obtaining the drift angle of the imaging device. The disclosed method may increase the accuracy of the drift angle.

Step 204: obtaining, by the aircraft, a zoom magnification of the imaging device.

In some embodiments, the aircraft may obtain the zoom magnification based on examining an imaging parameter of the imaging device.

Step 205: determining, by the aircraft, a control parameter of the gimbal based on the drift angle and the zoom magnification.

In some embodiments, the drift or vibration of the gimbal relates to the zoom magnification of the imaging device. That is, a slight drift or vibration may be magnified as the zoom magnification of the imaging device is increased. For example, when the imaging device is a high magnification camera, the higher the zoom magnification used in imaging, the higher the magnification by which the slight drift or vibration of the gimbal may be magnified. For example, if the imaging device is a Z30 high magnification camera with a 30 times optical zoom and a 6 times digital zoom, as the zoom magnification used in imaging is increased, the slight drift or vibration of the gimbal may be magnified by 20 times or more. Therefore, the aircraft may determine the control parameter of the gimbal based on the drift angle and the zoom magnification, such that the attitude of the gimbal may be adjusted based on the control parameter.

Step 206: adjusting, by the aircraft, an attitude of the gimbal based on the control parameter.

In some embodiments, the aircraft may adjust the attitude of the gimbal based on the control parameter.

It is understood that descriptions of these steps may also refer to the descriptions of corresponding steps shown in FIG. 1, which are not repeated.

In some embodiments, the aircraft may obtain the drift angle of the imaging device, and determine the control parameter of the gimbal based on the drift angle and the zoom magnification of the imaging device. The aircraft may adjust the attitude of the gimbal based on the control parameter of the gimbal. The disclosed method may be suitable for imaging devices having different zoom magnifications. The disclosed method may adaptively increase the stability of the tracking images.

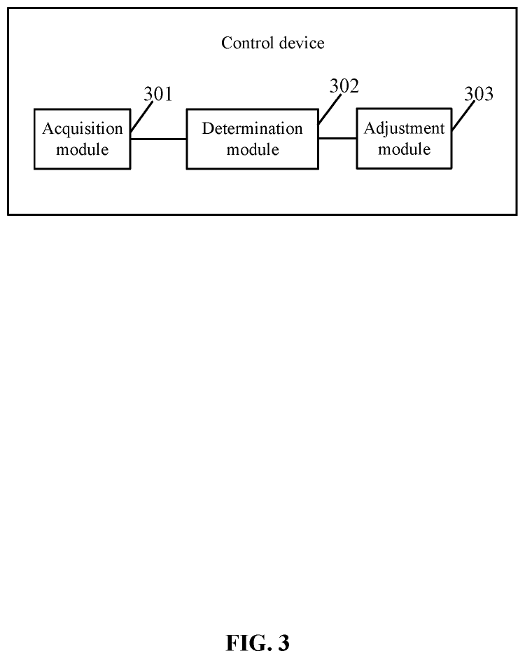

FIG. 3 is a schematic diagram of a control device according to an embodiment of the present disclosure. The device may be included in the gimbal, or included in the aircraft. The control device may include:

an acquisition module 301 configured to obtain a drift pixel of at least one target characteristic point in multiple frames of images; the multiple frames of images including images continuously captured by an imaging device;

a determination module 302 configured to determine a drift angle of the imaging device based on the drift pixel of the at least one target characteristic point and an imaging parameter of the imaging device;

an adjustment module 303 configured to adjust an attitude of a gimbal based on the drift angle.

In some embodiments, the acquisition module 301 may be configured to obtain multiple characteristic points from a central area (or region) of the first frame of image included in the multiple frames of images.

In some embodiments, the determination module 302 may be configured to filter the multiple characteristic points to obtain at least one target characteristic point based on location information of the multiple characteristic points in the multiple frames of images.

In some embodiments, the determination module 302 may be configured to determine, for each target characteristic point included in the at least one target characteristic point, a drift pixel of the target characteristic point in a horizontal direction and a drift pixel in a vertical direction based on multiple groups of drift pixels of the target characteristic point in the multiple frames of images.

In some embodiments, the determination module 302 may be configured to determine, for each target characteristic point included in the at least one target characteristic point, a drift angle corresponding to the target characteristic point based on the drift pixel of the target characteristic point and an imaging parameter of the imaging device; and determine a drift angle of the imaging device based on the drift angle corresponding to each target characteristic point included in the at least one target characteristic point.

In some embodiments, the determination module 302 may be configured to determine a field of view angle of the imaging device based on the imaging parameter of the imaging device; and determine the drift angle corresponding to the target characteristic point based on the field of view angle of the imaging device and the drift pixel of the target characteristic point.

In some embodiments, the adjustment module 303 may be configured to obtain a zoom magnification of the imaging device; determine a control parameter of a gimbal based on the drift angle and the zoom magnification; and adjust an attitude of the gimbal based on the control parameter.

In some embodiments, the control parameter may include one or more control parameters in a proportion integration differentiation (“PID”) control.

In some embodiments, the drift angle may include a drift distance in the horizontal direction and a drift distance in the vertical direction.

In some embodiments, the aircraft may obtain a drift pixel of at least one target characteristic point in multiple frames of images. The multiple frames of images may include images continuously captured by the imaging device. The aircraft may determine a drift angle of the imaging device based on the drift pixel of the at least one target characteristic point and an imaging parameter of the imaging device. The aircraft may adjust an attitude of a gimbal based on the drift angle, thereby adaptively increasing the stability of the tracking images.

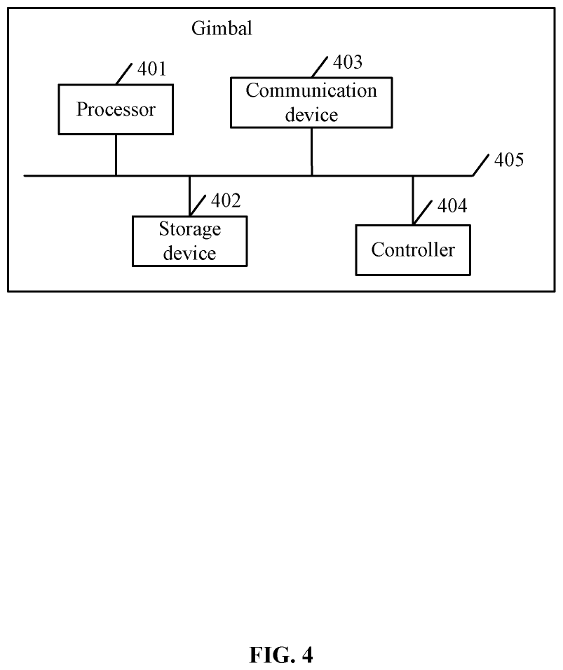

FIG. 4 is a schematic diagram of a gimbal according to an embodiment of the present disclosure. The gimbal may be configured to carry an imaging device. The gimbal shown in FIG. 4 may include at least one processor 401, such as a central processing unit (“CPU”), at least one storage device 402, a communication device 403, and a controller 404. The processor 401, the storage device 402, the communication device 403, and the controller 404 may be connected through a bus 405.

In some embodiments, the communication device 403 may be configured to receive and transmit data, such as to exchange information with the imaging device.

In some embodiments, the controller 404 may be configured to control the attitude of the gimbal.

In some embodiments, the storage device 402 may be configured to store program code. The processor 401 may be configured to retrieve the program code stored in the storage device 402.

In some embodiments, the processor 401 may retrieve the program code stored in the storage device 402, and execute the program code to perform the following operations:

obtaining a drift pixel of at least one target characteristic point in multiple frames of images, the multiple frames of images including images continuously captured by an imaging device;

determining a drift angle of the imaging device based on the drift pixel of the at least one target characteristic point and an imaging parameter of the imaging device; and

adjusting an attitude of a gimbal based on the drift angle.

In some embodiments, the processor 401 may retrieve the program code stored in the storage device 402, and execute the program code to perform the following additional operations:

obtaining multiple characteristic points from a central region of the first frame of image of the multiple frames of images; and

filtering the multiple characteristic points to obtain at least one target characteristic point based on location information of the multiple characteristic points in the multiple frames of images.

In some embodiments, the processor 401 may retrieve the program code stored in the storage device 402, and execute the program code to perform the following additional operations:

for each target characteristic point included in the at least one target characteristic point, determining a drift pixel of the target characteristic point in a horizontal direction and a drift pixel of the target characteristic point in a vertical direction, respectively, based on multiple groups of drift pixels of the target characteristic point in the multiple frames of images.

In some embodiments, the processor 401 may retrieve the program code stored in the storage device 402, and execute the program code to perform the following additional operations:

for each target characteristic point included in the at least one target characteristic point, determining a drift angle corresponding to the target characteristic point based on the drift pixel of the target characteristic point and an imaging parameter of the imaging device; and

determining a drift angle of the imaging device based on the drift angle corresponding to each target characteristic point included in the at least one target characteristic point.

In some embodiments, the processor 401 may retrieve the program code stored in the storage device 402, and execute the program code to perform the following additional operations:

determining a field of view angle of the imaging device based on the imaging parameter of the imaging device; and

determining a drift angle corresponding to the target characteristic point based on the field of view angle of the imaging device and a drift pixel of the target characteristic point.

In some embodiments, the processor 401 may retrieve the program code stored in the storage device 402, and execute the program code to perform the following additional operations:

obtaining a zoom magnification of the imaging device;

determining a control parameter of a gimbal based on the drift angle and the zoom magnification; and

adjusting an attitude of the gimbal based on the control parameter.

In some embodiments, the control parameter may include one or more control parameters in a proportion integration differentiation (“PID”) control.

In some embodiments, the drift angle may include a drift distance in a horizontal direction and a drift distance in a vertical direction.

In some embodiments, the aircraft may obtain a drift pixel of at least one target characteristic point in multiple frames of images. The multiple frames of images may include images continuously captured by an imaging device. The aircraft may determine a drift angle of the imaging device based on the drift pixel of the at least one target characteristic point and an imaging parameter of the imaging device. The aircraft may adjust an attitude of a gimbal based on the drift angle, thereby adaptively increasing the stability of the tracking images.

It is understood that in the above embodiments of the disclosed method, for simplicity of description, the method is described as a combination of a series of steps. A person having ordinary skills in the art can appreciate that the present disclosure is not limited by the sequence of the described steps because some steps may be executed in other orders or sequences, or may be executed simultaneously. In addition, a person having ordinary skills in the art can appreciate, the embodiments described in this specification are example embodiments, and one or more of the steps and modules included in these embodiments may be omitted.

A person having ordinary skills in the art can appreciate that all or some of the steps included in each embodiment of the disclosed method may be realized through a computer software program instructing related hardware. The program may be stored in a non-transitory computer-readable medium. The computer-readable medium may include a flash memory disk, a read-only memory (“ROM”), a random access memory (“RAM”), a magnetic disk, or an optical disk.

The above embodiments are only examples of the present disclosure, and do not limit the scope of the present disclosure. A person having ordinary skills in the art can understand all or some of the steps of the disclosed embodiments, and make equivalent modifications based on the claims of the present disclosure. Such modifications still fall within the scope of the present disclosure.

What is claimed is:

1. A method for controlling a gimbal, comprising:
obtaining a drift pixel of at least one target characteristic point in multiple frames of images;
determining a drift angle of an imaging device based on the drift pixel of the at least one target characteristic point and an imaging parameter of the imaging device; and
adjusting an attitude of the gimbal based on the drift angle.

2. The method of claim 1, wherein prior to obtaining the drift pixel of the at least one target characteristic point in the multiple frames of images, the method further comprises:
obtaining multiple characteristic points from a central region of a first frame of image in the multiple frames of images; and
filtering the multiple characteristic points to obtain the at least one target characteristic point based on location information of the multiple characteristic points in the multiple frames of images.

3. The method of claim 1, wherein obtaining the drift pixel of the at least one target characteristic point in the multiple frames of images comprises:
for a target characteristic point included in the at least one target characteristic point, determining a drift pixel of the target characteristic point in a horizontal direction and a drift pixel of the target characteristic point in a vertical direction, respectively, based on multiple groups of drift pixels of the target characteristic point in the multiple frames of images.

4. The method of claim 1, wherein determining the drift angle of the imaging device based on the drift pixel of the at least one target characteristic point and the imaging parameter of the imaging device comprises:
for a target characteristic point included in the at least one target characteristic point, determining a drift angle corresponding to the target characteristic point based on a drift pixel of the target characteristic point and the imaging parameter of the imaging device; and
determining the drift angle of the imaging device based on the drift angle corresponding to the target characteristic point included in the at least one target characteristic point.

5. The method of claim 4, wherein determining the drift angle of the target characteristic point based on the drift pixel of the target characteristic point and the imaging parameter of the imaging device comprises:
determining a field of view angle of the imaging device based on the imaging parameter of the imaging device; and
determining the drift angle corresponding to each target characteristic point based on the field of view angle of the imaging device and the drift pixel of the target characteristic point.

6. The method of claim 1, wherein adjusting the attitude of the gimbal based on the drift angle of the imaging device comprises:
obtaining a zoom magnification of the imaging device;
determining a control parameter of the gimbal based on the drift angle of the imaging device and the zoom magnification; and
adjusting the attitude of the gimbal based on the control parameter.

7. The method of claim 6, wherein
the control parameter comprises one or more control parameters of a proportion integration differentiation (“PID”) control, and
the drift angle of the imaging device comprises a drift distance in a horizontal direction and a drift distance in a vertical direction.

8. A gimbal, comprising:
a processor; and
a storage device connected with the processor, the storage device configured to store a computer-executable program code,
wherein the processor is configured to retrieve and execute the computer-executable program code to:
obtain a drift pixel of at least one target characteristic point in multiple frames of images;
determine a drift angle of an imaging device based on the drift pixel of the at least one target characteristic point and an imaging parameter of the imaging device; and
adjust an attitude of a gimbal based on the drift angle.

9. The gimbal of claim 8, wherein the processor is also configured to retrieve and execute the computer-executable program code to:
prior to obtaining the drift pixel of the at least one target characteristic point in the multiple frames of images,
obtain multiple characteristic points from a central region of a first frame of image in the multiple frames of images; and
filter the multiple characteristic points to obtain the at least one target characteristic point based on location information of the multiple characteristic points in the multiple frames of images.

10. The gimbal of claim 8, wherein the processor is also configured to retrieve and execute the computer-executable program code to:
for a target characteristic point included in the at least one target characteristic point, determine a drift pixel of the target characteristic point in a horizontal direction and a drift pixel of the target characteristic point in a vertical direction, respectively, based on multiple groups of drift pixels of the target characteristic point in the multiple frames of images.

11. The gimbal of claim 10, wherein the processor is also configured to retrieve and execute the computer-executable program code to:
for a target characteristic point included in the at least one target characteristic point, determine a drift angle corresponding to the target characteristic point based on a drift pixel of the target characteristic point and the imaging parameter of the imaging device; and
determine the drift angle of the imaging device based on the drift angle corresponding to the target characteristic point included in the at least one target characteristic point.

12. The gimbal of claim 11, wherein the processor is also configured to retrieve and execute the computer-executable program code to:
determine a field of view angle of the imaging device based on the imaging parameter of the imaging device; and
determine the drift angle corresponding to the target characteristic point based on the field of view angle of the imaging device and the drift pixel of the target characteristic point.

13. The gimbal of claim 8, wherein the processor is also configured to retrieve and execute the computer-executable program code to:
obtain a zoom magnification of the imaging device;
determine a control parameter of the gimbal based on the drift angle of the imaging device and the zoom magnification; and
adjust the attitude of the gimbal based on the control parameter.

14. The gimbal of claim 13, wherein
the control parameter comprises one or more control parameters of a proportion integration differentiation (“PID”) control, and
the drift angle of the imaging device comprises a drift distance in a horizontal direction and a drift distance in a vertical direction.

15. An unmanned aerial vehicle (“UAV”), comprising:
an imaging device; and
a gimbal comprising:
a processor; and
a storage device connected with the processor, the storage device configured to store a computer-executable program code,
wherein the processor is configured to retrieve and execute the computer-executable program code to:
obtain a drift pixel of at least one target characteristic point in multiple frames of images;
determine a drift angle of an imaging device based on the drift pixel of the at least one target characteristic point and an imaging parameter of the imaging device; and
adjust an attitude of the gimbal based on the drift angle, and
an airframe, wherein the imaging device is mounted to the gimbal, and the gimbal is mounted to the airframe.

16. The UAV of claim 15, wherein the processor is also configured to retrieve and execute the computer-executable program code to:
prior to obtaining the drift pixel of the at least one target characteristic point in the multiple frames of images,
obtain multiple characteristic points from a central region of a first frame of image in the multiple frames of images; and
filter the multiple characteristic points to obtain the at least one target characteristic point based on location information of the multiple characteristic points in the multiple frames of images.

17. The UAV of claim 15, wherein the processor is also configured to retrieve and execute the computer-executable program code to:
for a target characteristic point included in the at least one target characteristic point, determine a drift pixel of the target characteristic point in a horizontal direction and a drift pixel of the target characteristic point in a vertical direction, respectively, based on multiple groups of drift pixels of the target characteristic point in the multiple frames of images.

18. The UAV of claim 17, wherein the processor is also configured to retrieve and execute the computer-executable program code to:
for a target characteristic point included in the at least one target characteristic point, determine a drift angle corresponding to the target characteristic point based on a drift pixel of the target characteristic point and the imaging parameter of the imaging device; and
determine the drift angle of the imaging device based on the drift angle corresponding to the target characteristic point included in the at least one target characteristic point.

19. The UAV of claim 18, wherein the processor is also configured to retrieve and execute the computer-executable program code to:
determine a field of view angle of the imaging device based on the imaging parameter of the imaging device; and
determine the drift angle corresponding to the target characteristic point based on the field of view angle of the imaging device and the drift pixel of the target characteristic point.

20. The UAV of claim 15, wherein the processor is also configured to retrieve and execute the computer-executable program code to:
obtain a zoom magnification of the imaging device;
determine a control parameter of the gimbal based on the drift angle of the imaging device and the zoom magnification; and
adjust the attitude of the gimbal based on the control parameter.
